(19) United States
(12) Patent Application Publication
(10) Pub. No.: US 2018/0046021 A1
(43) Pub. Date: Feb. 15, 2018

(54) LIQUID CRYSTAL COMPOUND AND PREPARATION METHOD THEREOF, OPTICAL CUT-OFF COMPONENT AND MANUFACTURING METHOD THEREOF, AND DISPLAY DEVICE

(71) Applicant: BOE TECHNOLOGY GROUP CO., LTD., Beijing (CN)

(72) Inventor: Wenbo LI, Beijing (CN)

(73) Assignee: Boe Technology Group Co., Ltd., Beijing (CN)

(21) Appl. No.: 15/538,722

(22) PCT Filed: Oct. 21, 2016
(86) PCT No.: PCT/CN2016/102959

§ 371 Date: Jun. 22, 2017

(30) Foreign Application Priority Data
Apr. 7, 2016 (CN) 201610214352.6

(51) Int. Cl. G02F 1/1335; G02B 5/30; G02B 27/01; G02F 1/13363

(52) U.S. Cl. CPC G02F 1/133528; G02F 1/13363; G02B 5/3025; G02B 27/0172; G02F 2001/133543; G02B 2027/0178

(57) ABSTRACT

A liquid crystal compound and a preparation method thereof, an optical cut-off component and a manufacturing method thereof, and display devices. The liquid crystal compound, including: liquid crystal molecules; and chiral additives with certain concentration; wherein the chiral additives are mixed between the liquid crystal molecules, and the liquid crystal molecules are in cholesteric phase, so that the liquid crystal compound can reflect optical waves within the reflection wavelength range.

### TECHNICAL FIELD

Embodiments of the present disclosure relate to a liquid crystal compound and a preparation method thereof, an optical cut-off component and a manufacturing method thereof, a wearable display device and other display devices.

### BACKGROUND

Blue light is high-energy visible light and may cause photochemical damage to the retina of the eye. The blue light is widely used in artificial light sources. In a liquid crystal display (LCD) panel, a backlight structure tends to be lighter and thinner. Currently, light-emitting diode (LED) backlight design is mainly adopted, and an LED chip therein emits a large amount of blue light. In mobile products and intelligent wearable products, in order to improve the outdoor readability, high-brightness backlight structures are usually adopted, and blue light emitted by the backlight structures has higher intensity. Therefore, the possible damage of the blue light in the backlight on the eyes must be reduced.

In the prior art, a long wave pass cut-off filter is usually adopted to reduce the damage of the blue light on the eyes. As shown in FIG. 1, the long wave pass cut-off filter includes a dielectric film group 104 disposed on a substrate 102. The dielectric film group 104 includes several to dozens of layers of dielectric films with different refractive indexes and different thicknesses, combined according to design requirements. For instance, one layer of dielectric film is a high refractive index layer; another layer of dielectric film is a low refractive index layer; and the high refractive index layer and the low refractive index layer are alternately superimposed to form the dielectric film group 104. When light is incident into the high refractive index layer, reflected light has no phase shift; and when the light is incident into the low refractive index layer, the reflected light undergoes a 360° phase shift. The light reflected by the low refractive index layer and the light reflected by the high refractive index layer are superimposed. In this way, the light reflected by the multiple layers is superimposed at positions close to the center wavelength. Therefore, the prior art utilizes the optical films with a characteristic of specific wavelength selection to separate or combine different wavelengths.

In the production line process, multi-layer materials of the dielectric film group 104 may be subjected to thin film deposition on a substrate by plasma enhanced chemical vapor deposition (PECVD) process. For instance, high refractive index materials select silicon nitride (SiNx) and low refractive index materials select silicon dioxide (SiO2). However, the number of superimposed layers required by the dielectric film group 104 is at least more than 10, and the thickness of each layer must be strictly controlled, or else the wavelength range of the reflected light can be difficult to control.

### SUMMARY

A method for preparing a liquid crystal compound is provided in the embodiments of this disclosure, comprising: acquiring the reflection wavelength range of the liquid crystal compound; and forming the liquid crystal compound by adding chiral additives with certain concentration into liquid crystal molecules, so that the liquid crystal compound can reflect optical waves within the reflection wavelength range.

A method for manufacturing an optical cut-off component is provided in the embodiments of this disclosure, comprising: the method for preparing the liquid crystal compound; and forming a liquid crystal layer by curing the liquid crystal compound, in which the liquid crystal layer reflects optical waves within the reflection wavelength range.

A liquid crystal compound is provided in the embodiments of this disclosure, comprising: liquid crystal molecules; and chiral additives with certain concentration; wherein the chiral additives are mixed between the liquid crystal molecules, and the liquid crystal molecules are in cholesteric phase, so that the liquid crystal compound can reflect optical waves within the reflection wavelength range.

An optical cut-off component is provided in the embodiments of this disclosure, comprising: a liquid crystal layer formed by the liquid crystal compound wherein the liquid crystal layer reflects optical waves within the reflection wavelength range.

A wearable display device is provided in the embodiments of this disclosure, comprising: an optical cut-off component; a quarter-wave plate; and a wearable display unit. For instance, the wearable display unit includes an upper polarizer, a display panel, a lower polarizer, etc. The optical rotation of the upper polarizer and the quarter-wave plate is consistent with the optical rotation structure of liquid crystal molecules in a liquid crystal layer of the optical cut-off component.

A display device is provided in the embodiments of this disclosure, comprising: the optical cut-off component; a quarter-wave plate; and a display unit, wherein the display unit includes an upper polarizer, a display panel and a lower polarizer; and the optical rotation of the upper polarizer and the quarter-wave plate is consistent with the optical rotation structure of the liquid crystal molecules in the liquid crystal layer of the optical cut-off component.

### BRIEF DESCRIPTION OF THE DRAWINGS

In order to clearly illustrate the technical solution of the embodiments of the disclosure, the drawings of the embodiments will be briefly described in the following; it is obvious that the described drawings are only related to some embodiments of the disclosure and thus are not limitative of the disclosure.

FIG. 1 is a schematic structural view of a long wave pass cut-off filter in the prior art;

FIG. 2 is an illustrative schematic diagram of a cholesteric liquid crystal (CLC) layer;

FIG. 3 is an illustrative schematic diagram illustrating the light transmittance of CLC molecules;

FIG. 4A is a flow diagram 1 of a method for preparing a liquid crystal compound, provided by the embodiment of the present disclosure;

FIG. 4B is a flow diagram 2 of a method for preparing a liquid crystal compound, provided by the embodiment of the present disclosure;

FIG. 5 is a flow diagram illustrating the process of determining the pitch and the refraction indexes of liquid crystal molecules, in the embodiment of the present disclosure;

FIG. 6A is a schematic structural view of a display device provided by the embodiment of the present disclosure;

FIG. 6B is a schematic diagram illustrating the reflection and transmission of the display device as shown in FIG. 6A provided by the embodiment of the present disclosure; and

FIG. 7 is a schematic structural view of a wearable display device provided by the embodiment of the present disclosure.

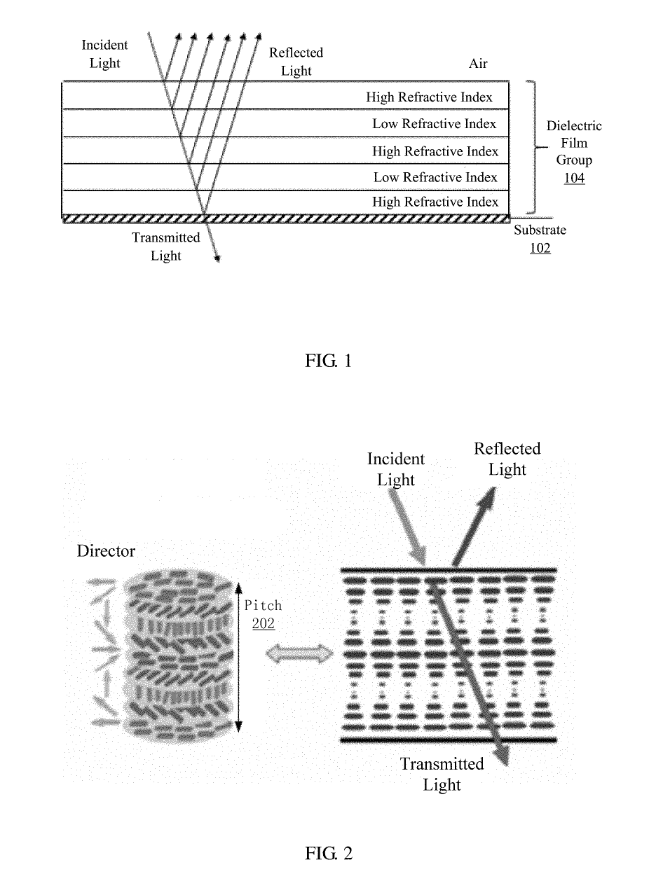

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

Cholesteric phase is an important phase of liquid crystal molecules. As shown in FIG. 2, the liquid crystal molecules in the cholesteric phase are arranged in layers and have continuous spiral structures. The liquid crystal molecules in cholesteric phase may selectively reflect incident light (similar to the Bragg reflection of crystals). For instance, the CLC molecules reflect circularly polarized light having the same rotary direction with the liquid crystal molecules and allow circularly polarized light having opposite rotary direction with the liquid crystal molecules to run through. The circularly polarized light running through the liquid crystal molecules becomes linearly polarized light after running through a quarter-wave plate. The quarter-wave plate is a birefringent single crystal wafer with certain thickness. When light is normally incident and transmitted, the phase difference between ordinary light (o light) and extraordinary light (e light) is π/2 or odd times of π/2.

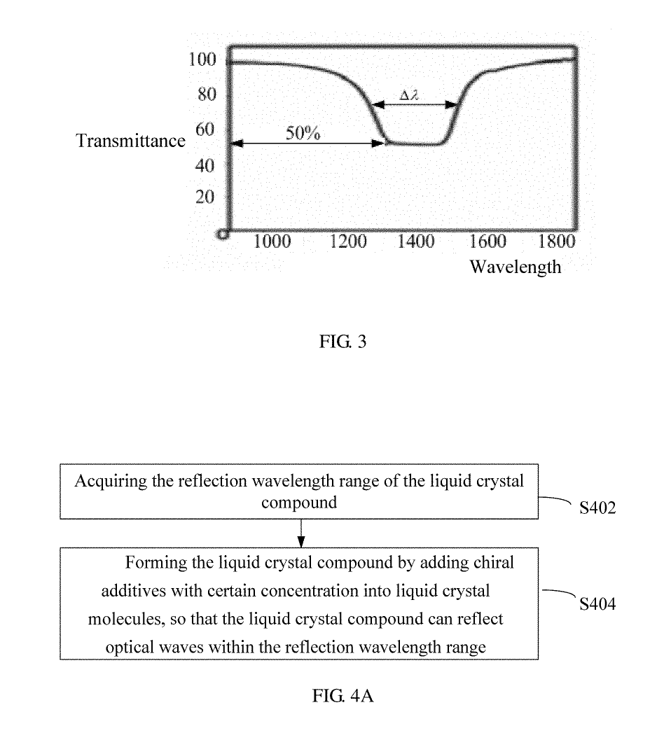

The CLC molecules may be left-handed liquid crystal molecules or right-handed liquid crystal molecules. Taking the left-handed liquid crystal molecules as an example, in the state of planar texture, liquid crystal molecules in different planes are respectively arranged in parallel in respective planes, and the alignment direction of liquid crystal molecules in adjacent planes changes and is spirally varied along the normal direction of the plane. As shown in FIG. 2, the pitch 202 of the liquid crystal molecules is the distance obtained when the alignment direction of the liquid crystal molecules undergoes 360° change. When incident light is incident into the left-handed liquid crystal molecules, the left-handed liquid crystal molecules perform Bragg reflection on partial incident light, and the other part of incident light will run through the liquid crystal molecules. The reflected light is left-handed circularly polarized light with certain wavelength or within a certain wavelength range, and the wavelength range may be referred to as reflection wavelength range or cut-off wavelength range; and the transmitted light is right-handed circularly polarized light or left-handed circularly polarized light not within the reflection wavelength range. Moreover, for instance, when the CLC molecules are right-handed liquid crystal molecules, the right-handed liquid crystal molecules perform Bragg reflection on partial incident light, and the other part of incident light will run through the liquid crystal molecules. The reflected light is right-handed circularly polarized light within a certain wavelength range, and the transmitted light is left-handed circularly polarized light or right-handed circularly polarized light not within the reflection wavelength range. Thus, the CLC molecules can realize selective reflection. For instance, as shown in FIG. 3, the transmittance of optical waves with the wavelength range of Δλ running through the CLC molecules is about 50%, namely partial optical waves within the wavelength range of Δλ are reflected or cut-off by the CLC molecules.

The embodiment of the present disclosure provides a method for preparing a liquid crystal compound, in which CLC molecules with certain pitch are formed by twisting the alignment of liquid crystal molecules by addition of chiral additives into the liquid crystal molecules. The CLC molecules may reflect optical waves within a certain wavelength range (namely cutting off the optical waves from running through the liquid crystal molecules); the reflection wavelength range is related to the pitch of the liquid crystal molecules; and the reflection wavelength range of the liquid crystal molecules may be changed by the variation of the pitch. The pitch of the liquid crystal molecules may be adjusted by adjusting the concentration of the chiral additives in the liquid crystal compound (for instance, when the concentration of the chiral additives is larger, the twisting of the liquid crystal molecules is easier). Thus, the wavelength range of the reflected or cut-off optical waves may be adjusted by adjusting the concentration of the chiral additives in the liquid crystal compound. Therefore, the embodiment of the present disclosure provides a method for controlling the reflection wave band of optical waves, which may control the reflection wave band of the optical waves by design of the liquid crystal structure, and hence can directly and effectively reduce the transmission of the optical waves within the reflection wave band. For instance, the embodiment of the present disclosure provides a method for controlling the reflection wave band of blue light, which may control the reflection wave band of the blue light by design of the liquid crystal structure, and hence can directly and effectively reduce the transmission of the blue light and reduce the damage of the blue light on the eyes.

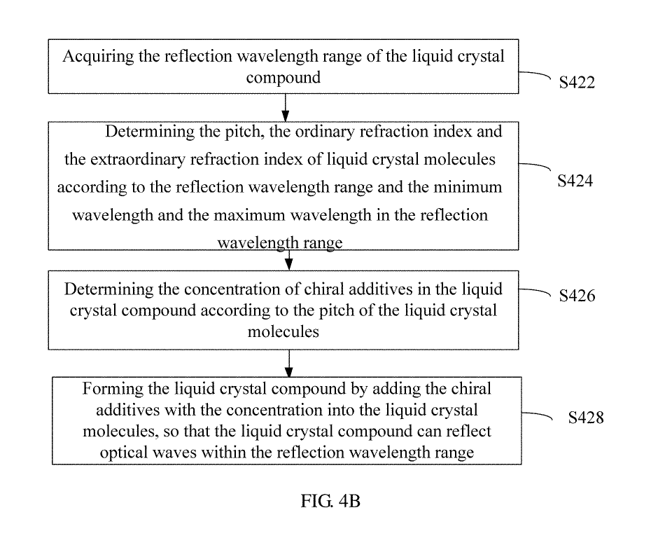

FIG. 4A is a flow diagram 1 of a method for preparing a liquid crystal compound, provided by the embodiment of the present disclosure. The method for preparing the liquid crystal compound comprises;

S402: acquiring the reflection wavelength range of the liquid crystal compound; and

S404: forming the liquid crystal compound by adding chiral additives with certain concentration into liquid crystal molecules, so that the liquid crystal compound can reflect optical waves within the reflection wavelength range.

For instance, in the liquid crystal compound, the liquid crystal molecules are CLC molecules, and the chiral additives are uniformly mixed between the liquid crystal molecules.

For instance, the reflected optical waves are blue light. The wavelength range of the blue light is 400 nm-480 nm; the half-peak breadth is 435 nm-450 nm; and the center wavelength is 440 nm. As the energy is larger when the wavelength is shorter, in the step S402, the range from 400 nm to 440 nm may be selected as the reflection wavelength range, so as to reduce the transmission of high-energy blue light. The embodiment of the present disclosure may also select other reflection wavelength ranges, so that the liquid crystal compound can reflect optical waves within other reflection wavelength ranges. No limitation will be given here in the present disclosure.

FIG. 4B is a flow diagram 2 of a method for preparing a liquid crystal compound, provided by the embodiment of the present disclosure. The method for preparing the liquid crystal compound comprises:

S422: acquiring the reflection wavelength range of the liquid crystal compound;

S424: determining the pitch, the ordinary refraction index and the extraordinary refraction index of liquid crystal molecules according to the reflection wavelength range and the minimum wavelength and the maximum wavelength in the reflection wavelength range;

S426: determining the concentration of chiral additives in the liquid crystal compound according to the pitch of the liquid crystal molecules; and

S428: forming the liquid crystal compound by adding the chiral additives with the concentration into the liquid crystal molecules, so that the liquid crystal compound can reflect optical waves within the reflection wavelength range.

For instance, the steps S422 and S428 as shown in FIG. 4B are respectively similar to the steps S402 and S404 as shown in FIG. 4A.

In the embodiment of the present disclosure, the reflection wavelength range Δλ is:

Δλ=λmax−λmin, (1)

where λmax refers to the maximum wavelength in the reflection wavelength range, and λmin refers to the minimum wavelength in the reflection wavelength range.

The relationship among the wavelength λ, the refractive index n of the liquid crystal molecules, and the pitch P of the liquid crystal molecules is:

λ=nP (2.1)

Wherein, the relationship among the minimum wavelength λmin, the ordinary refraction index no of the liquid crystal molecules, and the pitch P of the liquid crystal molecules is:

λmin=noP (2.2)

The relationship among the maximum wavelength λmax, the extraordinary refraction index ne of the liquid crystal molecules, and the pitch P of the liquid crystal molecules is:

λmax=neP (3)

The relationship among the birefringence Δn, the extraordinary refraction index ne and the ordinary refraction index no of the liquid crystal molecules is:

Δn=ne−no (4)

The relationship among the reflection wavelength range Δλ, the birefringence Δn and the pitch P of the liquid crystal molecules is:

Δλ=(ne−no)P=ΔnP (5)

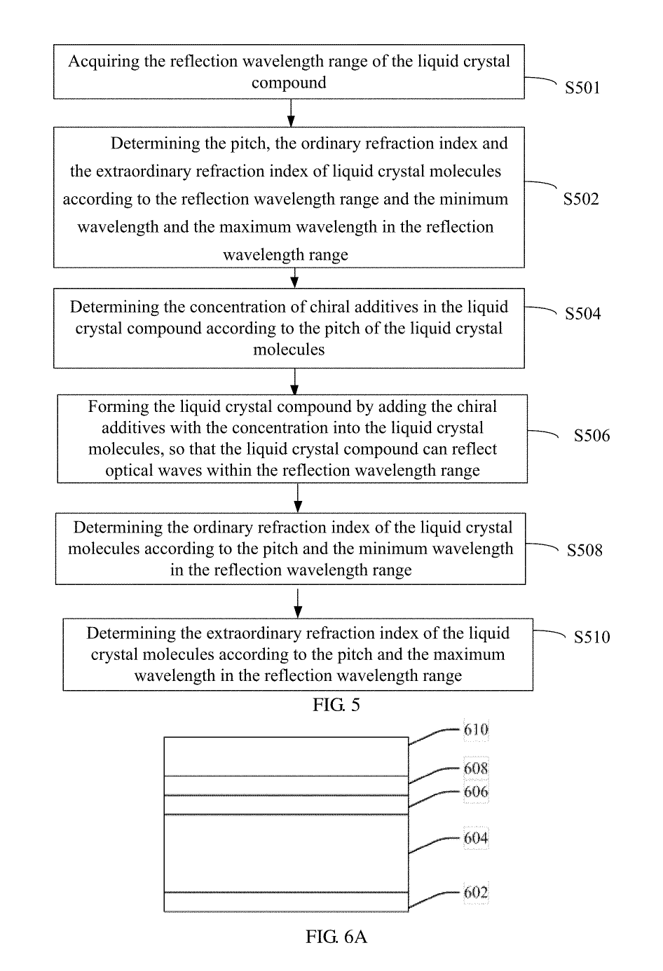

In the step S424, detailed description will be given to the step of determining the pitch P, and the ordinary refraction index no and the extraordinary refraction index ne of the liquid crystal molecules with reference to FIG. 5.

In the step S426, according to the pitch P of the liquid crystal molecules, the concentration C of the chiral additives in the liquid crystal compound may be determined as:

C=1/(P×HTP) (6)

where HTP refers to the inherent twisting energy constant of the liquid crystal molecules.

As can be seen from the steps S424 and S426, the pitch P of the liquid crystal molecules may be determined according to the reflection wavelength range Δλ (Δλ=λmax−λmin); and the concentration C of the chiral additives in the liquid crystal compound may be obtained from the above formula (6) according to the pitch P of the liquid crystal molecules. The liquid crystal molecules and the chiral additives in the liquid crystal compound are mixed according to the concentration C of the chiral additives, so that the liquid crystal compound can reflect the optical waves within a certain wavelength range, and hence the optical waves cannot run through the liquid crystal compound. In addition, the pitch P of the CLC molecules may be adjusted by adjusting the concentration C of the chiral additives in the liquid crystal compound, and the reflection wavelength range Δλ of the liquid crystal molecules may be changed by the variation of the pitch P; and hence the wavelength range Δλ of reflected or cut-off optical waves may be adjusted by adjusting the concentration C of the chiral additives in the liquid crystal compound.

FIG. 5 is a flow diagram of a method for determining the pitch P and the refraction indexes ne and no of the liquid crystal molecules. The method comprises:

S501: determining the pitch range of the liquid crystal molecules according to the reflection wavelength range Δλ;

S502: determining the birefringence range of the liquid crystal molecules according to the pitch range of the liquid crystal molecules;

S504: selecting the birefringence Δn of the liquid crystal molecules within the birefringence range;

S506: determining the pitch P of the liquid crystal molecules according to the birefringence Δn and the reflection wavelength range Δλ;

S508: determining the ordinary refraction index no of the liquid crystal molecules according to the pitch P and the minimum wavelength λmin in the reflection wavelength range Δλ; and

S510: determining the extraordinary refraction index ne of the liquid crystal molecules according to the pitch P and the maximum wavelength λmax in the reflection wavelength range.

Detailed description will be given below to the steps S501, S502, S504, S506 and S510 in FIG. 5 by taking the reflection of blue light with the wavelength of 400 nm-440 nm as an example. As the blue light with the wavelength of 400 nm-440 nm must be reflected, the reflection wavelength range is Δλ=440 nm-400 nm=40 nm; the minimum wavelength is λmin=400 nm; and the maximum wavelength is λmax=440 nm. Moreover, no,min≦ordinary refraction index no<extraordinary refraction index ne≦ne,max, in which no,min refers to the possible minimum of the ordinary refraction index no, and ne,max refers to the possible maximum of the extraordinary refraction index ne. For instance, the refractive index of the liquid crystal molecules is 1.5-1.9, namely no,min=1.5≦ordinary refraction index no<extraordinary refraction index ne≦ne,max=1.9.

In the step S501, it can be obtained from the above formula (2.1) that the first possible pitch range of the liquid crystal molecules is: (λmin/ne,max)≦P≦(λmin/no,min). For instance, when the minimum wavelength λmin=400 nm, no,min=1.5, ne,max=1.9, it can be obtained from the above formula (2.1) that the first possible pitch of the liquid crystal molecules is:

(λmin/1.9)≦P≦(λmin/1.5), namely 210.5 nm≦P≦266.7 nm. (7)

Similarly, it can be obtained that the second possible pitch range of the liquid crystal molecules is: (λmax/ne,max)≦P≦(λmax/no,min). For instance, when the maximum wavelength λmax=440 nm, no,min=1.5, ne,max=1.9, it can be obtained from the above formula (2.1) that the second possible pitch range of the liquid crystal molecules is:

(λmax/1.9)≦P≦(λmax/1.5), namely 231.6 nm≦P≦293.3 nm. (8)

The pitch range of the liquid crystal molecules may be determined as an overlapping part of the first possible pitch range and the second possible pitch range. The pitch range of the liquid crystal molecules may be represented as Pmin≦P≦Pmax. Thus, it can be obtained from the overlapping part of the ranges in the above formulas (7) and (8) that the pitch range of the pitch P is:

231.6 nm≦P≦266.7 nm, (9)

namely the minimum pitch is Pmin=231.1 nm, and the maximum pitch is Pmax=266.7 nm.

In the step S502, when the reflection wavelength range is Δλ=40 nm, it can be obtained from the pitch ranges in the above formulas (5) and (9) that the birefringence range of the liquid crystal molecules is:

(Δλ/Pmax)≦Δn≦(Δλ/Pmin),

namely 0.15≦Δn≦0.17 or 0.15≦ne−no≦0.17. (10)

In the step S504, the birefringence Δn of the liquid crystal molecules is selected in the birefringence range as shown in the above formula (10). For instance, for the sake of convenient description, the birefringence may be selected to be Δn=0.16. Of course, the birefringence Δn may also select other values.

In the step S506, for instance, according to the birefringence Δn=0.16, it can be obtained from the above formula (5) that the pitch P is:

P=Δλ/Δn=40 nm/0.16=250 nm.

In the step S508, it can be obtained from the above formula (2) that the ordinary refraction index no is about:

no=λmin/P=400 nm/250 nm=1.6.

In the step S510, it can be obtained from the above formula (3) that the extraordinary refraction index ne is about:

ne=λmax/P=440 nm/250 nm=1.76.

Therefore, the pitch P of the liquid crystal molecules may be selected to be 250 nm; the ordinary refraction index no is about 1.6; and the extraordinary refraction index ne is about 1.76.

In addition, as the inherent twisting energy constant of the liquid crystal molecules is relevant to the material, structure or other attributes of the liquid crystal molecules. When the material and the structure of the liquid crystal molecules are known, the inherent twisting energy constant of the liquid crystal molecules may be measured. The concentration C of the chiral additives may be obtained according to the obtained pitch P and the above formula (6). In addition, the concentration range of the chiral additives, when the liquid crystal molecules reflect the blue light with the wavelength of 400 nm-440 nm, may also be obtained according to the above formula (6) and the range of the pitch P obtained on the basis of the above formula (9). For instance, the range of the concentration C of the chiral additives is from 1/(Pmax×HTP) C to 1/(Pmin×HTP).

Of course, corresponding pitch P, ordinary refraction index no and extraordinary refraction index ne may be also obtained according to different values of birefringence Δn selected in the step S504.

It should be noted that the method as shown in FIG. 5 is only an illustrative method for determining the pitch P and the refraction indexes ne and no of the liquid crystal molecules. The pitch P and the refraction indexes ne and no of the liquid crystal molecules may also be obtained by other methods. No limitation will be given here in the present disclosure.

The embodiment of the present disclosure further provides a method for manufacturing an optical cut-off component, which comprises:

the method for preparing the liquid crystal compound as shown in FIG. 4A, FIG. 4B and/or FIG. 5; and

forming a liquid crystal layer by curing the liquid crystal compound, so that the liquid crystal layer can reflect optical waves within the reflection wavelength range.

In the method for manufacturing the optical cut-off component, the liquid crystal compound may be cured by the exposure of the liquid crystal compound or other commonly used manners. No further description will be given here in the present disclosure.

The embodiment of the present disclosure further provides an optical reflective liquid crystal compound, e.g., a blue light reflective liquid crystal compound. The liquid crystal compound comprises:

liquid crystal molecules; and

chiral additives with certain concentration, wherein

the chiral additives are mixed between the liquid crystal molecules, and the liquid crystal molecules are in cholesteric phase, so that the liquid crystal compound can reflect optical waves within he reflection wavelength range.

In some embodiments, with reference to FIG. 5, the pitch P, the ordinary refraction index no and the extraordinary refraction index ne of the liquid crystal molecules may be determined by the reflection wavelength range and the minimum wavelength and the maximum wavelength in the reflection wavelength range. For instance, the first possible pitch range of the liquid crystal molecules is: (λmin/ne,max)≦first possible pitch range≦(λmin/no,min); the second possible pitch range of the liquid crystal molecules is: (λmax/ne,max)≦second possible pitch range≦(λmax/no,min); and the range of the pitch P of the liquid crystal molecules is an overlapping part of the first possible pitch range and the second possible pitch range, in which no,min refers to the possible minimum of the ordinary reflection index no; ne,max refers to the possible maximum of the extraordinary reflection index ne; min refers to the minimum wavelength in the reflection wavelength range; and max refers to the maximum wavelength in the reflection wavelength range.

For instance, the range of the pitch P of the liquid crystal molecules satisfies: Pmin≦P≦Pmax, in which Pmin refers to the minimum of the pitch P, and Pmax refers to the maximum of the pitch P.

For instance, the range of the birefringence of the liquid crystal molecules satisfies: (Δλ/Pmax)≦Δn≦(Δλ/Pmin), in which Δn refers to the birefringence of the liquid crystal molecules, and Δλ refers to the reflection wavelength range.

For instance, the pitch P of the liquid crystal molecules also satisfies: P=Δλ/Δn.

For instance, the ordinary refraction index no of the liquid crystal molecules satisfies: no=λmin/P, in which no refers to the ordinary refraction index.

For instance, the extraordinary refraction index of the liquid crystal molecules satisfies: ne=λmax/P, in which ne refers to the extraordinary refraction index.

For instance, the concentration C of the chiral additives in the liquid crystal compound may be determined by the pitch P of the liquid crystal molecules. For instance, the relationship between the concentration of the chiral additives in the liquid crystal compound and the pitch of the liquid crystal molecules is:

C=1/(P×HTP)

where C refers to the concentration of the chiral additives in the liquid crystal compound, and HTP refers to the inherent twisting energy constant of the liquid crystal molecules.

For instance, the reflected optical waves are blue light, and the reflection wavelength range is 400 nm-440 nm. The reflection wavelength range may also be other wavelength ranges. No limitation will be given here in the present disclosure.

The embodiment of the present disclosure further provides an optical cut-off component, which comprises: a liquid crystal layer formed by the foregoing liquid crystal compound, wherein the liquid crystal layer reflects optical waves within the reflection wavelength range.

The embodiment of the present disclosure further provides an optical cut-off component for broad-band reflection, which comprises: a plurality of liquid crystal layers formed by a plurality of groups of liquid crystal compound, wherein the plurality of liquid crystal layers respectively reflect optical waves within a plurality of reflection wavelength ranges, and each liquid crystal layer reflects optical waves within one reflection wavelength range. The plurality of liquid crystal layers may be superimposed to form the optical cut-off component for broad-band reflection.

For instance, the optical cut-off component comprises: a first liquid crystal layer formed by a first liquid crystal compound, in which the first liquid crystal layer reflects optical waves within a first reflection wavelength range; and a second liquid crystal layer formed by a second liquid crystal compound, in which the second liquid crystal layer reflects optical waves within a second reflection wavelength range. The first liquid crystal compound is cured to form the first liquid crystal layer, and the second liquid crystal compound is cured to form the second liquid crystal layer. The first liquid crystal layer may be disposed on the second liquid crystal layer. Therefore, the optical cut-off component may reflect the optical waves within the first reflection wavelength range and the second reflection wavelength range.

For instance, the range of the birefringence Δn of the liquid crystal molecules is limited by liquid crystal materials. Currently, the range of the birefringence Δn is 0.1-0.4. It can be obtained from the relationship between a plurality of reflection wavelength ranges Δλ1, Δλ2, . . . , ΔλN and corresponding pitches P1, P2 . . . PN that:

Δλ1=Δn P1, Δλ2=Δn P2, . . . ,ΔλN=Δn PN,

namely Δλ1+Δλ2+ . . . +ΔλN==Δn(P1+P2+ . . . +PN).

Therefore, broad-band reflection may be realized by forming the liquid crystal layers with different pitch gradients in the optical cut-off component.

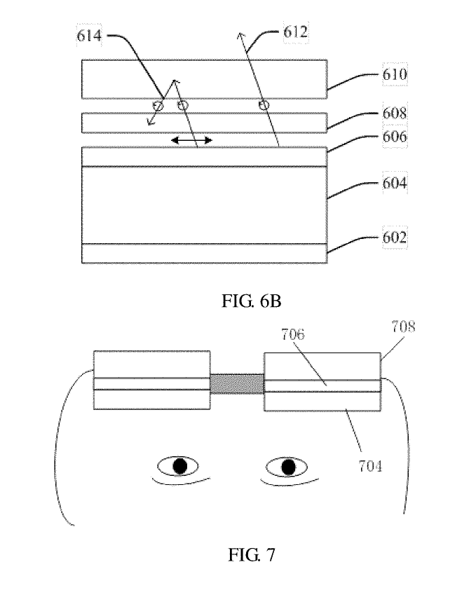

FIG. 6A illustrates the structure of a display device provided by the embodiment of the present disclosure. The display device comprises: an optical cut-off component 610; a quarter-wave plate 608; and a display unit. The display unit includes an upper polarizer 606, a display panel 604 and a lower polarizer 602. The display unit may be a display or other units with display function. As the optical cut-off component 610 may reflect optical waves within a certain wavelength range, the quarter-wave plate 608 may also achieve by adoption of corresponding broad-band design. No limitation will be given here in the present disclosure.

The optical rotation of the upper polarizer 606 and the quarter-wave plate 608 is consistent with the optical rotation structure of liquid crystal molecules in a liquid crystal layer of the optical cut-off component 610. For instance, the upper polarizer 606, the quarter-wave plate 608 and the optical cut-off component 610 are matched with each other in optical properties, and the pitch of the liquid crystal molecules in the liquid crystal layer of the optical cut-off component 610 is also matched with the reflection wavelength range, so selective reflection can be achieved.

As shown in FIG. 6B, light running through the upper polarizer 606 is linearly polarized light. In order to achieve the objective of matching the upper polarizer 606, the quarter-wave plate 608 and the optical cut-off component 610, when linearly polarized light emitted from the upper polarizer 606 is converted into left-handed polarized light after running through the quarter-wave plate 608, the liquid crystal molecules in the liquid crystal layer of the optical cut-off component 610 must be left-handed liquid crystal molecules and have pitch matched with the reflection wavelength range, so that the optical cut-off component 610 can reflect left-handed circularly polarized light 614 within the reflection wavelength range, but left-handed circularly polarized light 612 within other wavelength ranges will run through the optical cut-off component 610. For instance, left-handed circularly polarized blue light with the wavelength of 400 nm-440 nm may be reflected by the optical cut-off component, but left-handed circularly polarized light with other wavelengths will run through the optical cut-off component, so blue-light-proof design can be achieved.

Or when linearly polarized light emitted from the upper polarizer 606 is converted into right-handed polarized light after running through the quarter-wave plate 608, the liquid crystal molecules in the liquid crystal layer of the optical cut-off component 610 must be right-handed liquid crystal molecules and have pitch matched with the reflection wavelength range, so that the optical cut-off component can reflect right-handed circularly polarized light within the reflection wavelength range, but right-handed circularly polarized light within other wavelength ranges will run through the optical cut-off component. For instance, right-handed circularly polarized blue light with the wavelength of 400 nm-440 nm may be reflected by the optical cut-off component, but right-handed circularly polarized light with other wavelengths will run through the optical cut-off component, so blue-light-proof design can be achieved.

In some embodiments, the optical cut-off component 610 may also achieve the foregoing broad-band reflection and is configured to reflect optical waves within a plurality of reflection wavelength ranges.

FIG. 7 is a schematic structural view of a wearable display device provided by the embodiment of the present disclosure. The wearable display device comprises: an optical cut-off component 704; a quarter-wave plate 706; and a wearable display unit 708. For instance, the wearable display unit 708 includes an upper polarizer, a display panel, a lower polarizer, etc. The optical rotation of the upper polarizer and the quarter-wave plate 706 is consistent with the optical rotation structure of liquid crystal molecules in a liquid crystal layer of the optical cut-off component 704.

For instance, the wearable display unit 708 is wearable VR glasses, and the quarter-wave plate 706 and the optical cut-off component 704 are disposed on the inside of the VR glasses.

Light running through the upper polarizer of the wearable display unit 708 is linearly polarized light. In order to achieve the objective of matching the upper polarizer, the quarter-wave plate 706 and the optical cut-off component 704, when linearly polarized light emitted from the upper polarizer is converted into left-handed polarized light after running through the quarter-wave plate 706, the liquid crystal molecules in the liquid crystal layer of the optical cut-off component 704 must be left-handed liquid crystal molecules and have pitch matched with the reflection wavelength range, so that the optical cut-off component 704 can reflect left-handed circularly polarized light within the reflection wavelength range, but left-handed circularly polarized light within other wavelength ranges will run through the optical cut-off component 704. For instance, left-handed circularly polarized blue light with the wavelength of 400 nm-440 nm may be reflected by the optical cut-off component, but left-handed circularly polarized blue light in other wave bands and left-handed circularly polarized light with other wavelengths will run through the optical cut-off component, so blue-light-proof design can be achieved.

Or when linearly polarized light emitted from the upper polarizer is converted into right-handed polarized light after running through the quarter-wave plate 706, the liquid crystal molecules in the liquid crystal layer of the optical cut-off component 704 must be right-handed liquid crystal molecules and have pitch matched with the reflection wavelength range, so that the optical cut-off component can reflect right-handed circularly polarized light within the reflection wavelength range, but right-handed circularly polarized light within other wavelength ranges will run through the optical cut-off component. For instance, right-handed circularly polarized blue light with the wavelength of 400 nm-440 nm may be reflected by the optical cut-off component, but right-handed circularly polarized blue light in other wave bands and right-handed circularly polarized light with other wavelengths will run through the optical cut-off component, so blue-light-proof design can be achieved.

In some embodiments, the optical cut-off component 704 may also achieve the foregoing broad-band reflection and is configured to reflect optical waves within a plurality of reflection wavelength ranges.

The wearable display device may be blue-light-proof healthy wearable device, controls the reflected blue light wave band by design of the liquid crystal structure, and hence directly reduces the amount of blue light running through the wearable display device and arriving at human glasses, and reduces the damage of blue light on the eyes. The wearable display device may be applied in outdoor wearable products, VR wearable products or other products with high-brightness display.

Embodiments of the present disclosure provide a liquid crystal compound and a preparation method thereof, an optical cut-off component and a manufacturing method thereof, a display device and a wearable display device. In the liquid crystal compound, chiral additives are added into liquid crystal molecules, so that the alignment of the liquid crystal molecules can be twisted, and hence CLC molecules with certain pitch can be formed. The pitch of the liquid crystal molecules may be adjusted by adjusting the concentration of the chiral additives in the liquid crystal compound, so that the wavelength range of reflected or cut-off optical waves can be adjusted. Therefore, the embodiment of the present disclosure provides a method for controlling the reflection wave band of optical waves, which may control the reflection wave band of the optical waves by design of the liquid crystal structure, and hence directly and effectively reduce the transmission of optical waves in the reflection wave band. For instance, the embodiment of the present disclosure provides a method for controlling the reflection wave band of blue light, which may control the reflection wave band of the blue light by design of the liquid crystal structure, and hence directly and effectively reduce the transmission of the blue light and reduce the damage of the blue light on the eyes. Moreover, for instance, the liquid crystal compound and the preparation method thereof, the optical cut-off component and the manufacturing method thereof, the display device and the wearable display device, provided by the embodiment of the present disclosure, can prevent the transmission of high-energy blue light by reflection and hence reduce the damage of the high-energy blue light on the eyes, and meanwhile, can achieve the display function by allowing partial low-energy blue light and optical waves of other colors to run through.

Unless otherwise specified, the technical terms or scientific terms used in the present disclosure have normal meanings understood by those skilled in the art. The words “first”, “second” and the like used in the present disclosure do not indicate the sequence, the number or the importance but are only used for distinguishing different components. Similarly, the words “a”, “an”, “the” and the like also do not indicate the number but only indicate at least one. The word “comprise”, “include” or the like only indicates that an element or a component before the word contains elements or components and equivalents thereof listed after the word, not excluding other elements or components. The words “connection”, “connected” and the like are not limited to physical or mechanical connection but may include electrical connection, either directly or indirectly. The words “on”, “beneath”, “left”, “right” and the like only indicate the relative position relationship which is correspondingly changed when the absolute position of a described object is changed.

The accompanying drawings of the embodiments of the present disclosure only involve the structures relevant to the embodiments of the present disclosure, and other structures may refer to the prior art.

It should be understood that: when an element such as a layer, a film, an area or a substrate is referred to as being disposed “on” or “beneath” another element, the element may be “directly” disposed “on” or “beneath” another element, or an intermediate element may be provided.

The embodiments of the present disclosure and the characteristics in the embodiments may be mutually combined without conflict.

What are described above is related to the illustrative embodiments of the disclosure only and not limitative to the scope of the disclosure. Obvious variations and replacement by any one of the skilled person in the art in the technical scope of the disclosure should be all covered in the scope of this disclosure. The scopes of the disclosure are defined by the accompanying claims.

The present application claims the priority of the Chinese Patent Application No. 201610214352.6 filed on Apr. 7, 2016, which is incorporated herein in its entirety by reference as part of the disclosure of the present application.

1. A method for preparing a liquid crystal compound, comprising:
acquiring the reflection wavelength range of the liquid crystal compound; and
forming the liquid crystal compound by adding chiral additives with certain concentration into liquid crystal molecules, so that the liquid crystal compound can reflect optical waves within the reflection wavelength range.

2. The method for preparing the liquid crystal compound according to claim 1, wherein the liquid crystal molecules are in cholesteric phase; and the chiral additives are mixed between the liquid crystal molecules.

3. The method for preparing the liquid crystal compound according to claim 1, further comprising:
determining the pitch, the ordinary refraction index and the extraordinary refraction index of the liquid crystal molecules according to the reflection wavelength range and the minimum wavelength and the maximum wavelength in the reflection wavelength range.

4. The method for preparing the liquid crystal compound according to claim 3, further comprising:
determining the concentration of the chiral additives in the liquid crystal compound according to the pitch of the liquid crystal molecules before adding the chiral additives into the liquid crystal molecules.

5. The method for preparing the liquid crystal compound according to claim 3, wherein the step of determining the pitch, the ordinary refraction index and the extraordinary refraction index of the liquid crystal molecules includes:
determining the pitch range of the liquid crystal molecules according to the reflection wavelength range;
determining the birefringence range of the liquid crystal molecules according to the pitch range of the liquid crystal molecules;
selecting the birefringence of the liquid crystal molecules within the birefringence range;
determining the pitch of the liquid crystal molecules according to the birefringence and the reflection wavelength range;
determining the ordinary reflection index of the liquid crystal molecules according to the pitch and the minimum wavelength in the reflection wavelength range; and
determining the extraordinary reflection index of the liquid crystal molecules according to the pitch and the maximum wavelength in the reflection wavelength range.

6. The method for preparing the liquid crystal compound according to claim 5, wherein the step of determining the pitch range of the liquid crystal molecules according to the reflection wavelength range includes:
determining the first possible pitch range of the liquid crystal molecules to be: (λₘᵢₙ/n_{e,max})≦first possible pitch range ≦(λₘᵢₙ/n_{o,min});
determining the second possible pitch range of the liquid crystal molecules to be: (λₘₐₓ/n_{e,max})≦second possible pitch range ≦(λₘₐₓ/n_{o,min}); and
determining the pitch range of the liquid crystal molecules to be an overlapping part of the first possible pitch range and the second possible pitch range, in which
the pitch range is Pₘᵢₙ≦P≦Pₘₐₓ; P refers to the pitch of the liquid crystal molecules; Pₘᵢₙ refers to the minimum of the pitch P; Pₘₐₓ refers to the maximum of the pitch P; n_{o,min} refers to the possible minimum of the ordinary reflection index nₒ; n_{e,max} refers to the possible maximum of the extraordinary reflection index nₑ; λₘᵢₙ refers to the minimum wavelength in the reflection wavelength range; and λₘₐₓ refers to the maximum wavelength in the reflection wavelength range.

7. The method for preparing the liquid crystal compound according to claim 6, wherein the step of determining the birefringence range of the liquid crystal molecules according to the pitch range of the liquid crystal molecules includes:
determining the birefringence range of the liquid crystal molecules to be: (Δλ/Pₘₐₓ)≦Δn≦(Δλ/Pₘᵢₙ), in which Δn refers to the birefringence of the liquid crystal molecules, and Δλ refers to the reflection wavelength range.

8. The method for preparing the liquid crystal compound according to claim 7, wherein
the step of determining the pitch of the liquid crystal molecules according to the birefringence and the reflection wavelength range includes: determining the pitch P to be P=Δλ/Δn;
the step of determining the ordinary reflection index of the liquid crystal molecules according to the pitch and the minimum wavelength in the reflection wavelength range includes: determining the ordinary reflection index nₒ to be nₒ=λₘᵢₙ/P; and
the step of determining the extraordinary reflection index of the liquid crystal molecules according to the pitch and the maximum wavelength in the reflection wavelength range includes: determining the extraordinary reflection index nₑ to be nₑ=λₘₐₓ/P.

9. The method for preparing the liquid crystal compound according to claim 1, wherein the reflected optical waves are blue light; and the reflection wavelength range is 400 nm-440 nm.

10. A method for manufacturing an optical cut-off component, comprising:
the method for preparing the liquid crystal compound according to claim 1; and
forming a liquid crystal layer by curing the liquid crystal compound, in which the liquid crystal layer reflects optical waves within the reflection wavelength range.

11. A liquid crystal compound, comprising:
liquid crystal molecules; and
chiral additives with certain concentration; wherein
the chiral additives are mixed between the liquid crystal molecules, and the liquid crystal molecules are in cholesteric phase, so that the liquid crystal compound can reflect optical waves within the reflection wavelength range.

12. The liquid crystal compound according to claim 11, wherein the relationship between the concentration of the chiral additives in the liquid crystal compound and the pitch of the liquid crystal molecules is:
C=1/(P×HTP), in which
C refers to the concentration of the chiral additives in the liquid crystal compound; HTP refers to the inherent twisting energy constant of the liquid crystal molecules; and P refers to the pitch of the liquid crystal molecules.

13. The liquid crystal compound according to claim 12, wherein
the pitch P of the liquid crystal molecules satisfies: Pₘᵢₙ≦P≦Pₘₐₓ, in which Pₘᵢₙ refers to the minimum of the pitch P, and Pₘₐₓ refers to the maximum of the pitch P;
the range of the birefringence of the liquid crystal molecules satisfies: (Δλ/Pₘₐₓ)≦Δn≦(Δλ/Pₘᵢₙ), in which Δn refers to the birefringence of the liquid crystal molecules, and Δλ refers to the reflection wavelength range;
the pitch P of the liquid crystal molecules also satisfies: P=Δλ/Δn;
the ordinary reflection index no of the liquid crystal molecules satisfies: nₒ=λₘᵢₙ/P, in which nₒ refers to the ordinary reflection index, and λₘᵢₙ refers to the minimum wavelength in the reflection wavelength range; and
the extraordinary reflection index of the liquid crystal molecules satisfies: nₑ=λmax/P, in which nₑ refers to the extraordinary reflection index, and λmax refers to the maximum wavelength of the reflection wavelength range.

14. The liquid crystal compound according to claim 13, wherein
the first possible pitch range of the liquid crystal molecules is: (Δₘᵢₙ/n_{e,max})≦first possible pitch range ≦(λₘᵢₙ/n_{o,min});
the second possible pitch range of the liquid crystal molecules is: (λₘₐₓ/n_{e,max})≦second possible pitch ranges≦(λₘₐₓ/n_{o,min}); and
the range of the pitch P of the liquid crystal molecules is an overlapping part of the first possible pitch range and the second possible pitch range, in which
n_{o,min} refers to the possible minimum of the ordinary reflection index nₒ, and n_{e,max} refers to the possible maximum of the extraordinary reflection index nₑ.

15. The liquid crystal compound according to claim 13, wherein the reflected optical waves are blue light; the reflection wavelength range is 400 nm-440 nm; and the concentration C of the chiral additives is ranged from 1/(Pₘₐₓ×HTP) to 1/(Pₘᵢₙ×HTP), in which HTPrefers to the inherent twisting energy constant of the liquid crystal molecules.

16. An optical cut-off component, comprising: a liquid crystal layer formed by the liquid crystal compound according to claim 11, wherein the liquid crystal layer reflects optical waves within the reflection wavelength range.

17. A display device, comprising:
the optical cut-off component according to claim 16;
a quarter-wave plate; and
a display unit, wherein
the display unit includes an upper polarizer, a display panel and a lower polarizer; and the optical rotation of the upper polarizer and the quarter-wave plate is consistent with the optical rotation structure of the liquid crystal molecules in the liquid crystal layer of the optical cut-off component.

18. The display device according to claim 17, wherein the wearable display unit is wearable virtual reality (VR) glasses; and the quarter-wave plate and the optical cut-off component are disposed on the inside of the VR glasses.

19. The display device according to claim 17, wherein
light running through the upper polarizer is linearly polarized light;
light running through the quarter-wave plate is left-handed polarized light;
the liquid crystal molecules of the liquid crystal layer in the optical cut-off component are left-handed liquid crystal molecules; and
the optical cut-off component reflects left-handed circularly polarized light within the reflection wavelength range.

20. The display device according to claim 17, wherein
light running through the upper polarizer is linearly polarized light;
light running through the quarter-wave plate is right-handed polarized light;
the liquid crystal molecules of the liquid crystal layer in the optical cut-off component are right-handed liquid crystal molecules; and
the optical cut-off component reflects right-handed circularly polarized light within the reflection wavelength range.
